(19) United States
(12) Patent Application Publication
(10) Pub. No.: US 2004/0094414 A1
(43) Pub. Date: May 20, 2004

(54) Biosensor, biosensor array, method for producing an electrode of a biosensor , method for producing a biosensor

(76) Inventors: Manfred Engelhardt, Feldkirchen-Westerham (DE); Alexander Frey, Munchen (DE); Franz Hofmann, Munchen (DE); Christl Lauterbach, Hohenkirchen-Siegertsbrunn (DE); Roland Thewes, Grobenzell (DE)

Correspondence Address: Jeffrey R Stone, Briggs And Morgan, 2400 IDS Center, Mineapolis, MN, 55402, US

(21) Appl. No.: 10/239,098

(22) PCT Filed: Mar. 29, 2001
(86) PCT No.: PCT/DE01/01242

(30) Foreign Application Priority Data
Mar. 30, 2000 (DE) 100-15-822.6

(51) Int. Cl. G01N 27/26

(52) U.S. Cl. 204/403.14; 29/592.1

(57) ABSTRACT

The invention relates to a biosensor that is provided with a first electrode having a first holding area and a second electrode having a second holding area for holding probe molecules which can bind macromolecular biopolymers to be detected. The first electrode and the second electrode are arranged in relation to one another in such a way that essentially unbent field lines of a generated electric field can be embodied between said electrodes.

The invention relates to a biosensor, biosensor arrays, methods for producing an electrode of a biosensor and methods for producing a biosensor.

A biosensor of this type, a biosensor array of this type and methods of this type are known from [1].

FIG. 2a and FIG. 2b show such a sensor, as described in [1]. The sensor 200 has two electrodes 201, 202 made of gold, which are embedded in an insulator layer 203 made of insulator material. Electrode terminals 204, 205, to which the electrical potential applied to the electrode 201, 202 can be delivered, are connected to the electrodes 201, 202. The electrodes 201, 202 are arranged as planar electrodes. DNA probe molecules 206 are immobilized on each electrode 201, 202 (cf. FIG. 2a). The immobilization may be carried out according to the so-called gold-sulfur coupling. Alternatively, the immobilization may take place by means of a material which has been coated onto the electrode. The analyte to be studied, for example an electrolyte 207, is applied to the electrodes 201, 202.

If DNA strands 208 with a sequence which is complementary to the sequence of the DNA probe molecules 206 are contained in the electrolyte 207, then these DNA strands 208 hybridize with the DNA probe molecules 206 (cf. FIG. 2b).

Hybridization of a DNA probe molecule 206 and a DNA strand 208 takes place only if the sequences of the respective DNA probe molecule 206 and of the corresponding DNA strand 208 are complementary to one another. If this is not the case, then no hybridization takes place. A DNA probe molecule with a predetermined sequence is hence respectively able to bind, i.e. hybridize with, only a particular DNA strand, namely the one with the complementary sequence in each case.

If hybridization takes place, then as can be seen from FIG. 2b, the value of the impedance between the electrodes 201, 202 becomes modified. This modified impedance is determined by applying an AC voltage with an amplitude of approximately 50 mV to the electrode terminals 204, 205 and the resulting current by means of a connected measuring instrument (not shown).

In the event of hybridization, the capacitive component of the impedance between the electrodes 201, 202 is reduced. This is attributable to the fact that both the. DNA probe molecules 206 and the DNA strands 208, which may hybridize with the DNA probe molecules 206 if appropriate, are non-conductive and therefore clearly shield the respective electrode 201, 202 electrically to a certain extent.

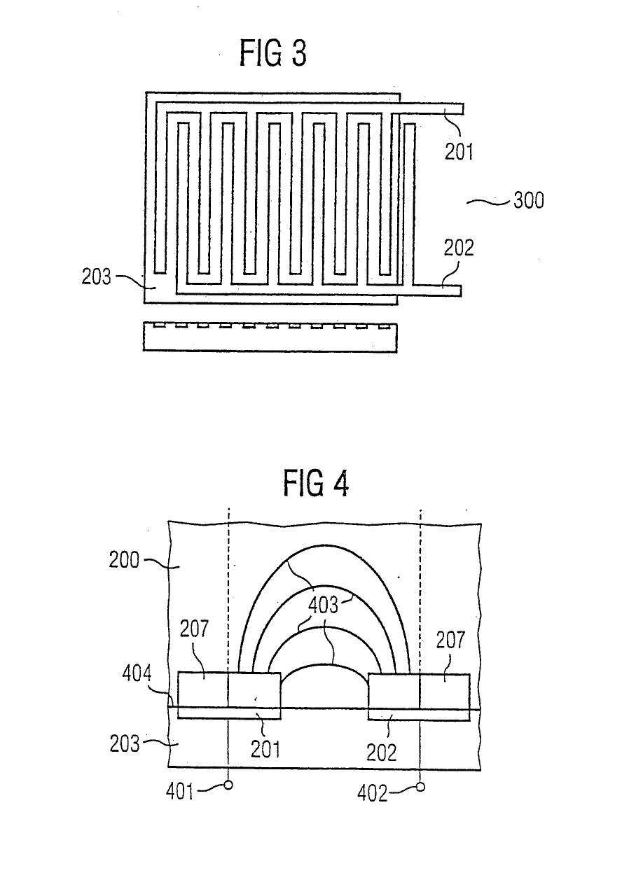

In order to improve the measurement accuracy, it is also known from [7] to use a plurality of electrode pairs 201, 202 and to connect them in parallel, these being clearly arranged interdigitated with one another, so that a so-called interdigitated electrode 300 is obtained, as illustrated in FIG. 3. The dimensioning of the electrodes and the distances between the electrodes are of the order of the length of the molecules to be detected, i.e. of the DNA strands 208 or less, for example in the region of 200 nm and less.

A further procedure for studying the electrolyte with respect to the existence of a DNA strand with a predetermined sequence is known from [2]. In this procedure, the DNA strands with the desired sequence are marked and, on the basis of the reflection properties of the marked molecules, the existence thereof is determined. To that end, light in the visible wavelength range is shone onto the electrolyte, and the light reflected by the electrolyte, in particular by the marked DNA strand to be registered, is detected. On the basis of the reflection response, i.e. in particular on the basis of the detected, reflected light beams, the question of whether or not the DNA strand to be registered, with the correspondingly predetermined sequence, is or is not contained in the electrolyte is determined.

This procedure is highly elaborate, since very accurate knowledge about the reflection response of the corresponding DNA strand is required and, furthermore, it is necessary to mark the DNA strands before the start of the method. Furthermore, very accurate adjustment of the recording means for recording the reflected light beams is required, in order to be able to record the reflected light beams at all.

This procedure is therefore expensive, complicated and highly sensitive to perturbing effects, so that it is very easy for the measurement result to be vitiated.

It is furthermore known from affinity chromatography (cf. [3]) to use immobilized low molecular weight molecules, in particular ligands with high specificity and affinity, in order to specifically bind peptides and proteins, e.g. enzymes, in an analyte.

Furthermore, [4] has disclosed a method for producing a metal structure comprising platinum on a substrate with side walls which are substantially perpendicular to the surface of the substrate.

Furthermore, what is known as the Damascene technique is known for the production of an electrical metal contact for a field-effect transistor from [5].

Furthermore, [6] has disclosed a method for producing a self-aligning metallization for a field-effect transistor on a semiconductor body having a rib. In this method, a gold surface is applied over the entire surface of the semiconductor body. At the edges of the rib, a gap is etched at the sides of the rib into the gold layer, which has grown in porous form at those locations. The base width of the gap is determined by the duration of the etching process.

In the case of the planar electrodes which are known from [1], one particular drawback is that they have a relatively low sensitivity with respect to electrical recording of the macromolecular biopolymers, which can easily lead to distortions in the measurement result on account of even slight external interference, for example as a result of noise.

Therefore, the invention is based on the problem of providing a biosensor having a sensitivity which is increased compared to the biosensor according to the prior art. Furthermore, the invention is based on the problem of providing methods for producing a biosensor of this type and electrodes of a biosensor of this type.

The problem is solved by the biosensor, the biosensor array, the methods for producing an electrode of a biosensor and by the methods for producing a biosensor having the features described in the independent patent claims.

A biosensor has a first electrode and a second electrode. The first electrode has a first holding region for holding molecules which can bind macromolecular biopolymers which are to be recorded. The second electrode has a second holding region for holding molecules which can bind the macromolecular biopolymers which are to be recorded. The first electrode and the second electrode are arranged in such a manner relative to one another that substantially uncurved field lines of an electric field produced between the first electrode and the second electrode can form between the first holding region and the second holding region.

The first holding region may be provided with a first immobilization layer and/or the second holding region may be provided with a second immobilization layer.

In the context of the present invention, the term immobilization layer is to be understood as meaning a layer having a material which can immobilize probe molecules.

The term macromolecular biopolymers is to be understood as meaning, by way of example, proteins or peptides or DNA strands with in each case a predetermined sequence.

If proteins or peptides are to be recorded as macromolecular biopolymers, the first molecules and the second molecules are ligands, for example active substances with a possible binding activity, which bind the proteins or peptides which are to be recorded to the electrode in question, on which the corresponding ligands are arranged.

Suitable ligands are enzyme agonists or enzyme antagonists, pharmaceuticals, sugars or antibodies or any molecule which has the ability to specifically bind proteins or peptides.

If the macromolecular biopolymers used are DNA strands of a predetermined sequence which are to be recorded by means of the biosensor, the biosensor can be used to hybridize DNA strands of a predetermined sequence with DNA probe molecules having a sequence which is complementary to the sequence of the DNA strands, as molecules on the first electrode.

In the context of the present description, the term probe molecule is to be understood as meaning both a ligand and a DNA probe molecule.

The first holding region and the second holding region may be designed to hold probe molecules to which peptides or proteins can be bound.

Alternatively, the first holding region and the second holding region can be designed to hold DNA probe molecules to which DNA molecules can be bound.

The first holding region and the second holding region may include at least one of the following materials: hydroxyl radicals, epoxy radicals, amine radicals, acetoxy radicals, isocyanate radicals, succinimidyl ester radicals, thiol radicals, gold, silver, platinum, titanium.

Furthermore, the first holding region and the second holding region may be formed substantially parallel to one another or concentrically around one another.

In particular, the first electrode and the second electrode may form two walls which are arranged on a substrate, are positioned opposite one another and are substantially perpendicular to the substrate.

Furthermore, according to one configuration of the invention, the first electrode and the second electrode are of cuboidal design.

Furthermore, the first electrode and the second electrode may be of cylindrical form and may be arranged concentrically.

Furthermore, the first electrode and the second electrode may be of polygonal form, in such a manner that respective polygon surfaces of the first electrode and of the second electrode are positioned opposite one another. Obviously, therefore, according to this refinement the two electrodes, in plan view, form two, preferably concentric, interlinked polygons in which individual walls of the polygons of the two electrodes are arranged opposite one another and substantially parallel to one another.

Furthermore, according to a refinement of the invention, the biosensor may be designed in such a manner that the second electrode is clearly T-shaped and inner surfaces of the part of the second electrode which is arranged substantially parallel to the first electrode is arranged above the latter.

In other words, what this means is that the first electrode is applied to an electrically insulating substrate. The second electrode is applied to the electrically insulating substrate, in such a manner

that the second electrode, together with the substrate and the first electrode, forms a cavity, and

the second electrode is arranged partially above the first electrode,

that the surfaces of the second electrode in the cavity which are arranged above the first electrode are substantially parallel to the surface of the first electrode in the cavity.

The second electrode forms an opening in the cavity which is sufficiently large to allow the macromolecular biopolymers which are to be recorded to pass into the cavity.

Furthermore, a plurality of first electrodes and a plurality of second electrodes may be provided, and the first electrodes and the second electrodes may be connected in parallel, so that they form an interdigitated electrode arrangement.

Furthermore, the electrodes may be produced from gold, silver, platinum or titanium.

Furthermore, there is a biosensor array having a multiplicity of biosensors as explained above.

According to one configuration of the invention, in a biosensor array of this type, electrodes of opposite electrical polarity are in each case arranged immediately adjacent to the electrodes of the same electrical polarity, so that an electric field can be formed between the electrodes of respectively opposite electrical polarity, i.e. different electrical potential.

A biosensor can be produced by forming a structure, the shape of which corresponds to a first electrode which is to be formed, in a substrate comprising electrically insulating material. The structure is at least completely filled with electrode material, and the electrode material which is situated above and outside the structure is removed, with the result that the first electrode is formed. In a further step, substantially vertical walls, comprising electrode material, of a second electrode which is to be formed are formed, the substantially vertical walls being electrically insulated from the first electrode. Then, an auxiliary layer is applied to the substrate to a maximum height of the substantially vertical walls, and an electrode layer is applied to the auxiliary layer, in such a manner that the electrode layer is coupled in an electrically conductive manner to the substantially vertical walls. Furthermore, an opening is formed in the electrode layer. In a final step, the auxiliary layer is at least partially removed, through the opening, in the space formed by the electrode layer, the substrate, the first electrode, the substantially vertical walls and the electrode layer.

According to a further method, an electrode of a biosensor is produced by a structure, the shape of which corresponds to an electrode which is to be formed, being formed in a substrate comprising electrically insulating material. The structure is at least completely filled with electrode material and the electrode material which is situated above and outside the structure is removed, so that the electrode is formed in the substrate.

Obviously, this procedure can be regarded as consisting in the Damascene technique for production of an electrical metal contact for a field-effect transistor now being used for the production of an electrode of a biosensor.

According to a further configuration of the invention, the auxiliary layer is completely removed.

Furthermore, the auxiliary layer can be removed by means of dry etching, which preferably takes place in a downstream plasma.

Furthermore, an electrode of a biosensor can be produced as a result of a first electrode layer comprising electrode material being applied to a substrate having a metallization for an electrical connection of the biosensor which is to be formed. In a further step, an auxiliary layer comprising electrically insulating material is applied to the first electrode layer, and the auxiliary layer is structured in such a manner that a structure which is in the form of at least one electrode which is to be formed, with substantially vertical walls, results. A second electrode layer comprising electrode material is applied to the first electrode layer and the remaining auxiliary layer, in such a manner that the vertical walls of the structure are covered with electrode material and the electrode material is removed apart from the electrode material at the vertical side walls and immediately below the structure.

According to a refinement of the invention, as part of the structuring, resist structures whose lateral dimensions correspond to the electrode which is to be produced are produced by means of photolithography.

Furthermore, in this context silicon oxide can be used for the auxiliary layer.

It is also possible for an etching stop layer to be formed on the substrate, and according to a refinement of the invention for this etching stop layer to include silicon nitride.

Furthermore, the electrode material can be removed by means of a polishing process, preferably by means of a chemical mechanical polishing process.

Alternatively, it is possible to produce an electrode of a biosensor as a result of an electrode layer comprising electrode material being applied to a substrate having a metallization for an electrical connection of the biosensor which is to be formed. A resist layer comprising photoresist is applied to the electrode layer, the thickness of the resist layer substantially corresponding to the height of the electrode of the biosensor which is to be formed. The resist layer is structured in such a manner that the lateral dimensions of the structure produced correspond to the electrode which is to be produced. The regions of the electrode layer which have been uncovered by the structuring are removed in such a manner that, during the removal, in a redeposition process electrode material accumulates at the substantially vertical walls of the structured resist layer.

The electrode material of the uncovered regions can be removed by means of sputtering.

According to a further alternative embodiment of the invention, it is possible to produce an electrode of a biosensor as a result of a stepped structure with side walls of a predetermined steepness being formed in a substrate. A metal adhesion layer is applied to the substrate, and a metal layer is vapor-deposited on the metal adhesion layer.

At each edge of the stepped structure, the metal layer is opened up in a self-aligning manner, so that a gap is formed in the metal layer in such a manner that the metal electrodes are electrically insulated from the metal electrodes which in each case directly adjoin them.

By way of example, one of the following materials can be used as the metal adhesion layer: titanium, tungsten, nickel-chromium or molybdenum.

By way of example, one of the following materials can be used for the metal layer: gold, silver, platinum, titanium.

According to a refinement of the invention, each step of the stepped structure has a height of at least 100 nm. The steepness of the individual steps is preferably very great and is preferably at least 50°, i.e. it is possible to form steps with substantially vertical walls.

The metal layer which is formed in each case should be sufficiently thick for the metal layer to grow together in porous form over the entire surface of the metal adhesion layer. A metal layer thickness of approximately 500 nm to 2000 nm has proven sufficient.

The metal layer can be opened up in a self-aligning manner as a result of the metal layer being etched at the edges of the stepped structure. The etching may take place by means of wet etching.

Exemplary embodiments of the invention are illustrated in the figures and are explained in more detail below.

In the drawing:

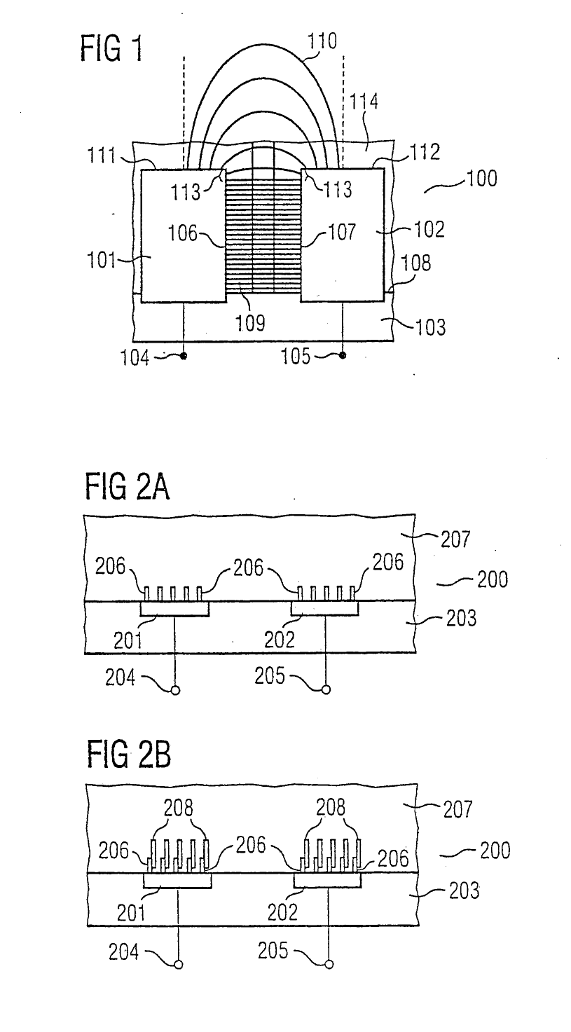

FIG. 1 shows a biosensor in accordance with an exemplary embodiment of the invention;

FIGS. 2a and 2b show a sketch of two planar electrodes, by means of which the existence of DNA strands which are to be recorded in an electrolyte (FIG. 2a) or their non-existence (FIG. 2b) can be detected;

FIG. 3 shows interdigitated electrodes according to the prior art;

FIG. 4 shows a planar electrode arrangement with field lines of an applied electric field between the planar electrodes drawn in;

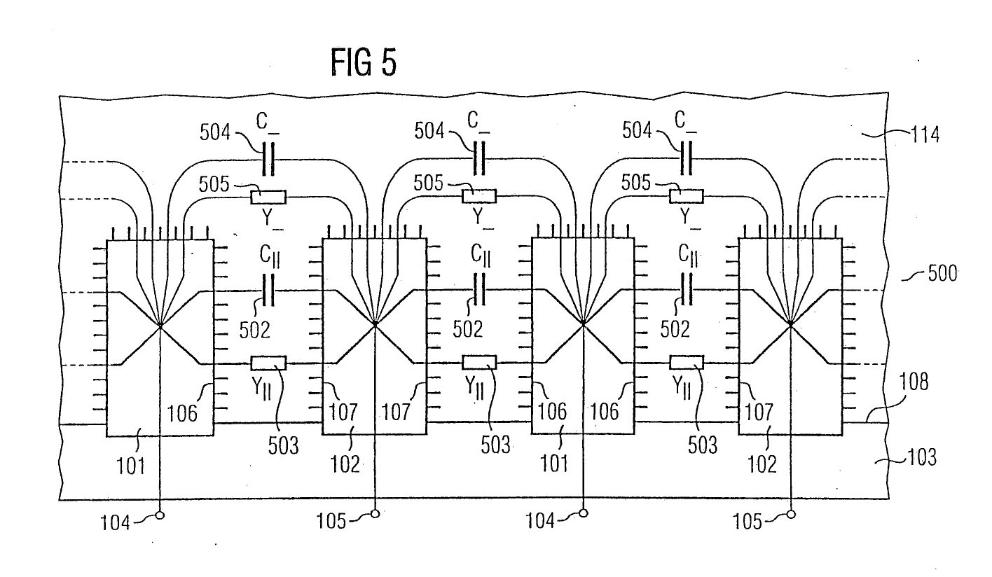

FIG. 5 shows a cross section through a biosensor with two electrodes, which are arranged as an interdigitated electrode arrangement;

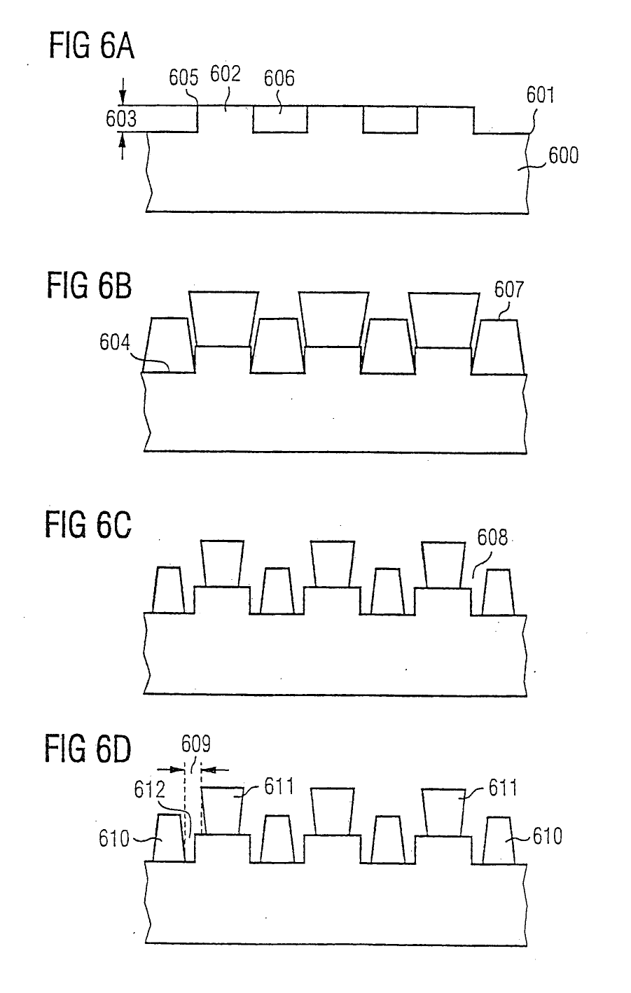

FIGS. 6a to 6d show cross-sectional views of an interdigitated electrode in four method states in a method for producing a biosensor according to an exemplary embodiment of the invention;

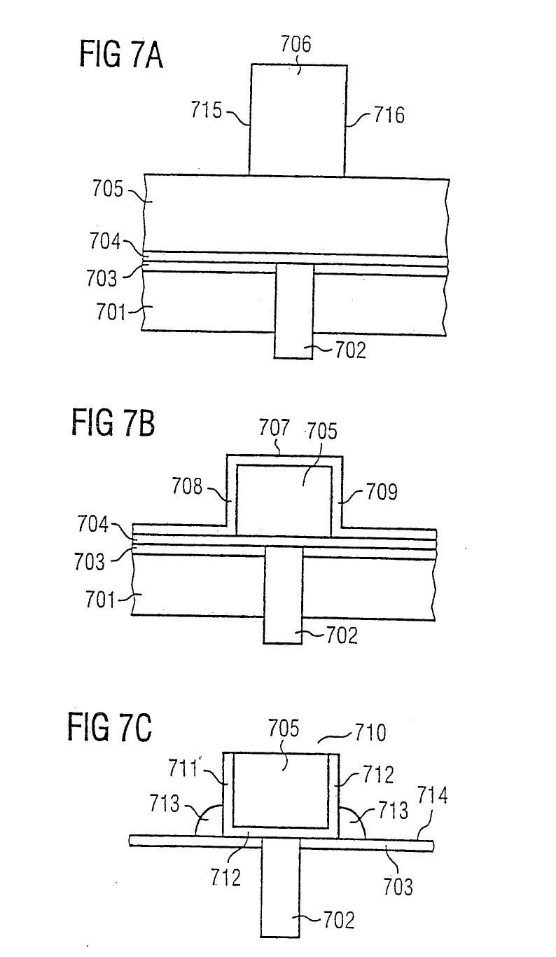

FIGS. 7a to 7c show cross-sectional views of a biosensor during individual method steps of the method for producing an electrode of the biosensor according to a further exemplary embodiment of the invention;

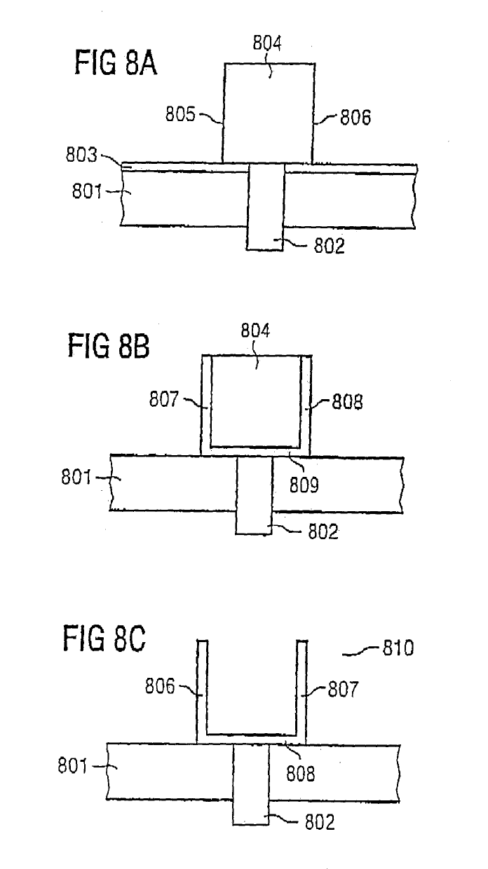

FIGS. 8a to 8c show cross-sectional views of a biosensor during individual method steps of the method for producing an electrode of the biosensor according to a further exemplary embodiment of the invention;

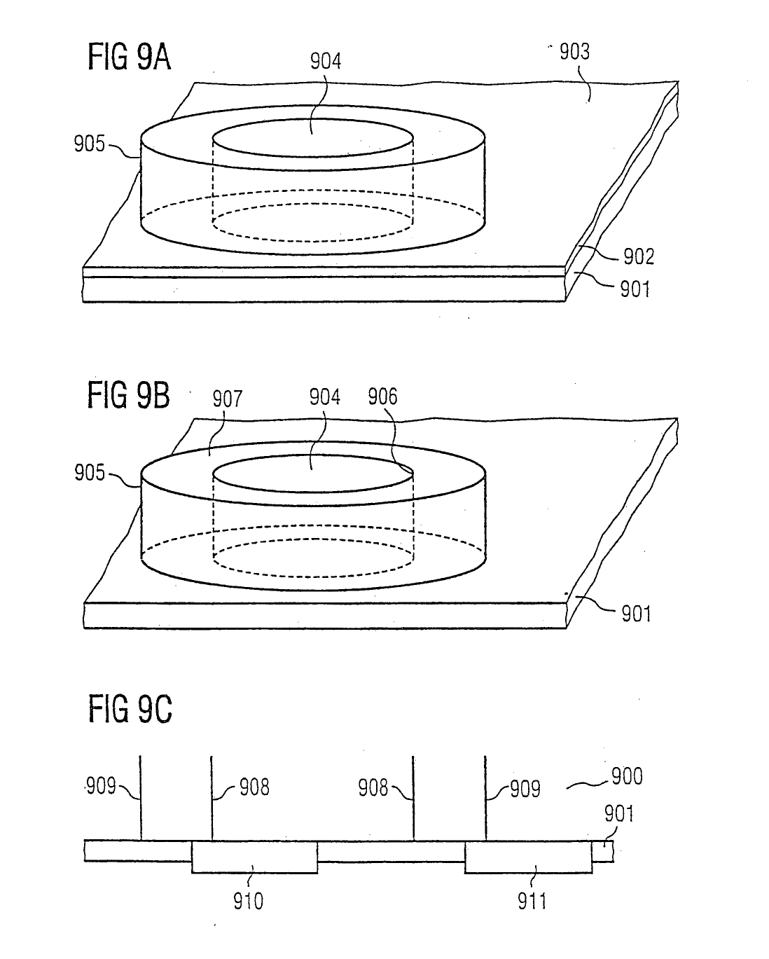

FIGS. 9a to 9c respectively show a cross section through a biosensor at various times during the production method according to a further exemplary embodiment of the invention;

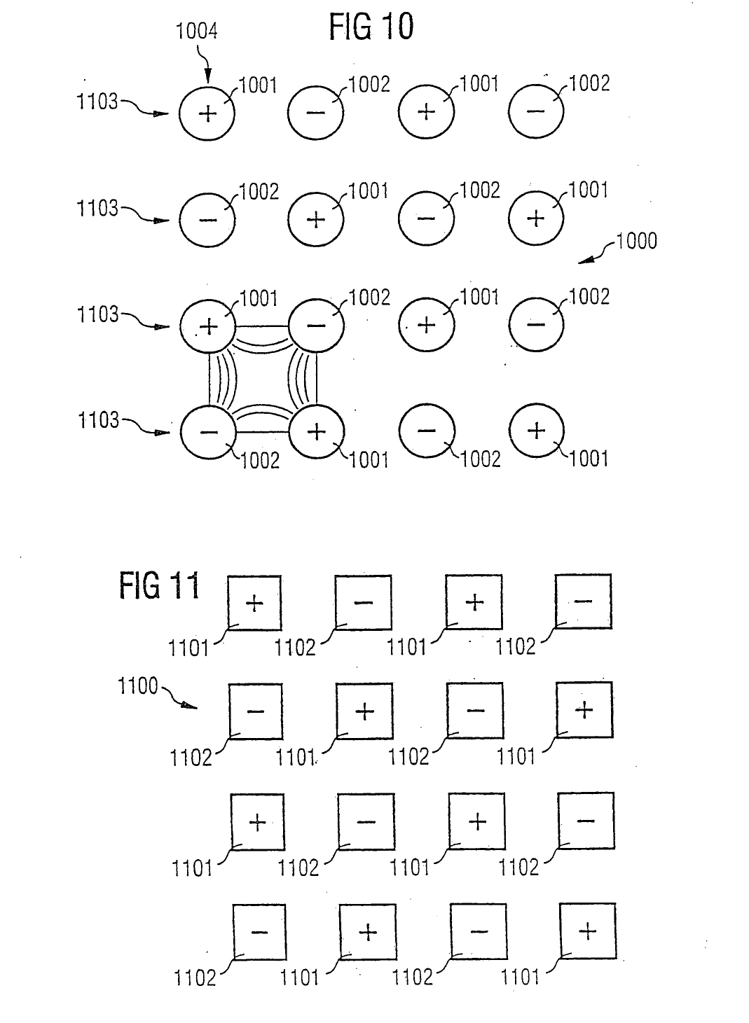

FIG. 10 shows a plan view of a biosensor array according to an exemplary embodiment of the invention with cylindrical electrodes;

FIG. 11 shows a plan view of a biosensor array according to an exemplary embodiment of the invention with cuboid electrodes;

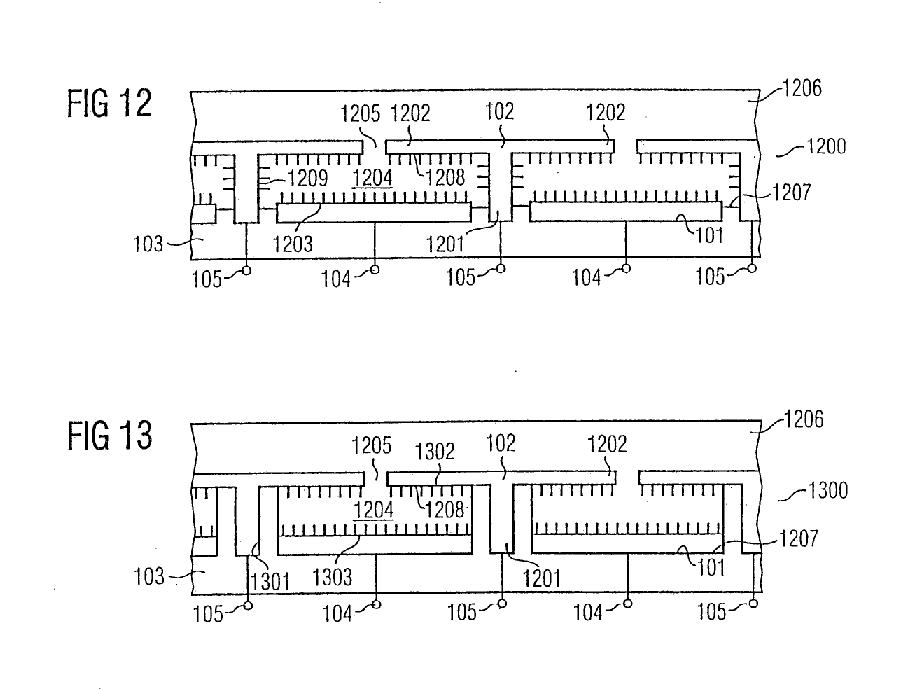

FIG. 12 shows a cross-sectional view of a biosensor according to a further exemplary embodiment of the invention;

FIG. 13 shows a cross-sectional view of a biosensor according to a further exemplary embodiment of the invention; and

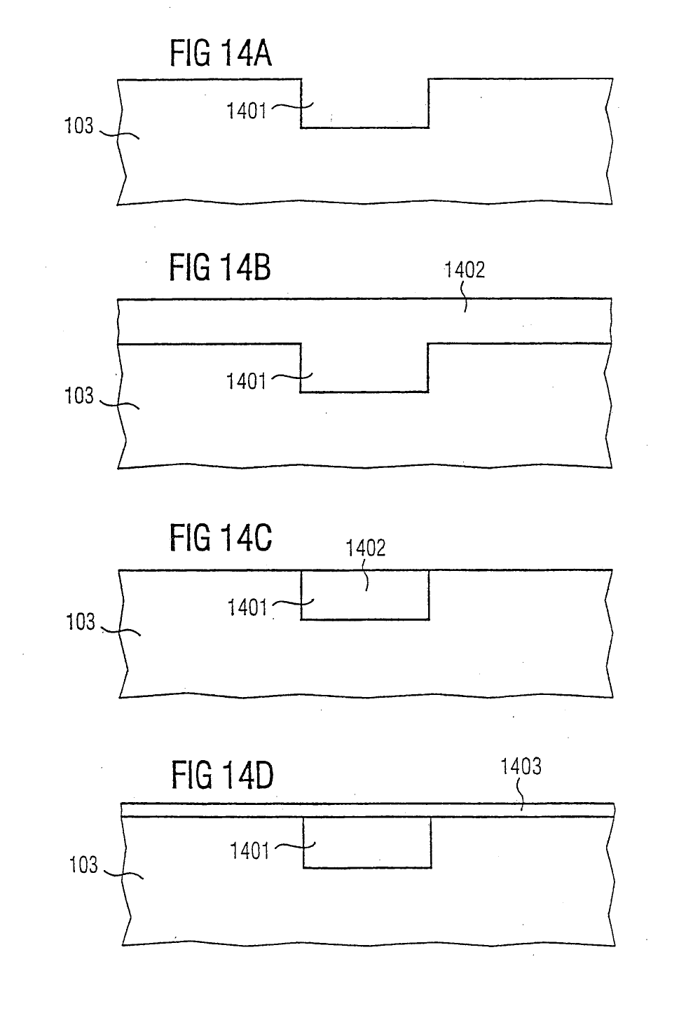

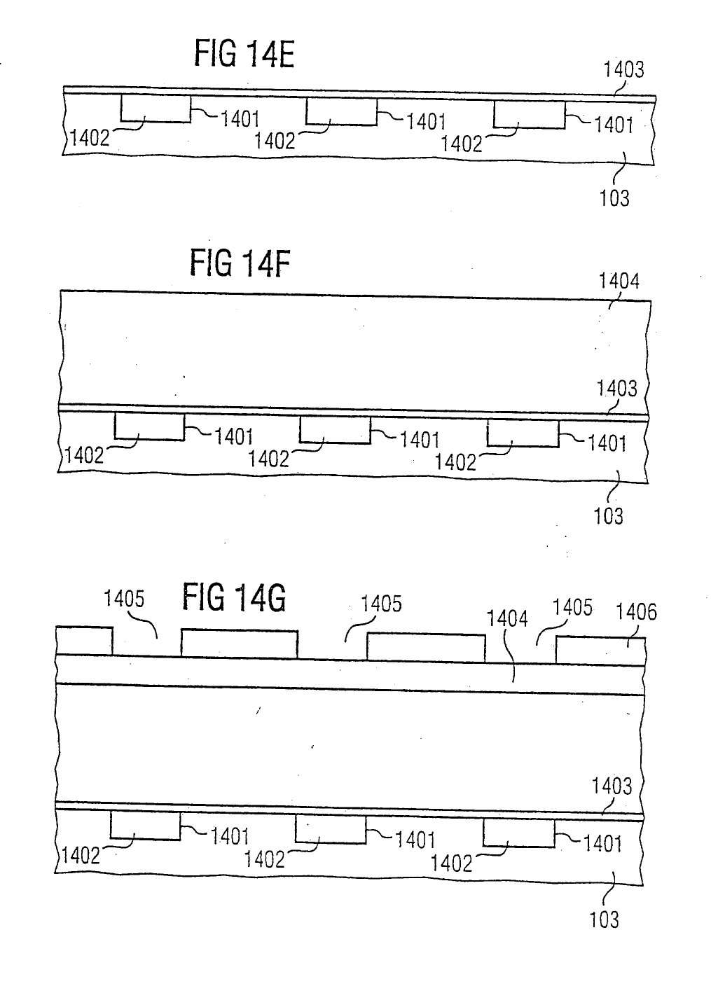

FIGS. 14a to 14g show cross-sectional views of a biosensor during individual method steps of a production method according to a further exemplary embodiment of the invention.

To explain the invention, the discovery on which the inventive principle has obviously been based is explained with reference to the sensor 200 which is known from [1] and has planar electrodes, i.e. has the first electrode 201 and the second electrode 202.

FIG. 4 shows the sensor 200 with the first electrode 201 and the second electrode 202 and the associated electrical connections, a first electrical connection 401 and a second electrical connection 402.

Furthermore, FIG. 4 shows field lines 403 of an electric field which is applied between the first electrode 201 and the second electrode 202.

As can be seen from FIG. 4, when an electric field is applied between the planar electrodes, the result is an electric field with field lines 403 which are exclusively curved with respect to the surface plane 404 which is formed by the insulator layer 203.

According to the invention, it has been recognized that the curved field lines are essentially responsible for the relatively poor sensitivity of the biosensor 200 having the planar electrodes 201, 202 in the region which is of interest, i.e. in particular in the holding regions.

Therefore, the invention has provided a biosensor in which, obviously, the electrodes are in each case arranged in such a manner that the holding regions of the electrodes, or at least a large part of the surface of the holding regions, are arranged substantially parallel to and opposite one another, so that most of the field lines, which start from the electrodes, of an applied electric field between the electrodes have a substantially uncurved profile of the field lines of the electric field through the active regions, i.e. in the volume in which the probe molecules with the macromolecular biopolymers which are to be recorded are arranged on the respective electrodes.

First Exemplary Embodiment:

FIG. 1 shows a biosensor 100 in accordance with a first exemplary embodiment.

The biosensor 100 has a first electrode 101 and a second electrode 102, which are arranged on an insulator layer 103 in such a manner that the first electrode 101 and the second electrode 102 are electrically insulated from one another.

The first electrode is coupled to a first electrical connection 104, and the second electrode 102 is coupled to a second electrical connection 105.

The electrodes 101, 102 have a cuboidal structure, with a first electrode surface 106 of the first electrode 101 and a first electrode surface 107 of the second electrode 102 being positioned opposite one another and oriented substantially parallel to one another.

This is achieved by the fact that, according to this exemplary embodiment, the electrodes 101, 102 have side walls 106, 107 which are substantially perpendicular with respect to the surface 108 of the insulator layer 103 and which form the first electrode surface 106 of the first electrode 101 and the first electrode surface 107 of the second electrode 102.

If an electric field is applied between the first electrode 101 and the second electrode 102, a field line profile with field lines 109 which are substantially uncurved between the surfaces 106, 107 is produced by the electrode surfaces 106, 107 which are oriented substantially parallel to one another.

Curved field lines 110 result only between a second electrode surface 111 of the first electrode 101 and a second electrode surface 112 of the second electrode 102, which in each case form the upper surfaces of the electrodes 101, 102, and in an edge region 113 between the electrodes 101, 102.

The first electrode surfaces 106, 107 of the electrodes 101, 102 are formed as holding regions for holding probe molecules, which can bind macromolecular biopolymers, which are to be recorded by means of the biosensor 100.

According to this exemplary embodiment, the electrodes 101, 102 are made from gold.

Covalent bonds are produced between the electrodes and the probe molecules, the sulfur for forming a gold-sulfur coupling being present in the form of a sulfide or a thiol.

If DNA probe molecules are used as probe molecules, sulfur functionalities of this type are part of a modified nucleotide, which, by means of what is known as phosphoramidite chemistry, is incorporated at the 3′ end or at the 5′ end of the DNA strand which is to be immobilized during an automated DNA synthesis method. The DNA probe molecule is therefore immobilized at its 3′ end or at its 5′ end.

If ligands are used as the probe molecules, the sulfur functionalities are formed by one end of an alkyl linker or of an alkylene linker, the other end of which has a chemical functionality which is suitable for the covalent bonding of the ligand, for example a hydroxyl radical, an acetoxy radical or a succinimidyl ester radical.

The electrodes, i.e. in particular the holding regions, are covered during measurement use with an electrolyte 114, in general with a solution which is to be analyzed.

If the solution 114 which is to be analyzed contains the macromolecular biopolymers which are to be recorded, for example DNA strands of a predetermined sequence which are to be recorded and which can hybridize with the immobilized DNA probe molecules on the electrodes, then the DNA strands hybridize with the DNA probe molecules.

If the solution 114 which is to be analyzed does not contain any DNA strands with the sequence which is complementary to the sequence of the DNA probe molecules, then no DNA strands from the solution 114 which is to be analyzed can hybridize with the DNA probe molecules on the electrodes 101, 102.

These two different states result in different capacitances between the electrodes 101, 102 for the biosensor 100, which can be recorded by means of a measuring appliance (not shown).

The change in the capacitance between the electrodes 101, 102 is used to work out whether or not the solution 114 which is to be analyzed contains the DNA strands which are to be recorded.

Second Exemplary Embodiment:

FIG. 5 shows a biosensor 500 in accordance with a second exemplary embodiment of the invention.

In the biosensor 500, in the same way as in the biosensor 100 according to the first exemplary embodiment, two electrodes 101, 102 are provided which are applied on the insulator layer 103.

In contrast to the biosensor 100 with only two cuboid electrodes, the two electrodes according to the biosensor 500 represented in FIG. 5 are arranged as a plurality of respectively alternately arranged, parallel-connected electrodes in the form of the known interdigitated electrode arrangement.

For further illustration, FIG. 5 also shows a schematic electrical equivalent circuit diagram, which is indicated in the representation of the biosensor 500.

Since essentially uncurved field lines occur with respect to the surface 108 of the insulator layer 103 between the electrode faces 106, 107 of the electrodes 101, 102, which face one another while being essentially parallel, as was represented in FIG. 1 in connection with the first exemplary embodiment, the component of the first capacitance 502 and of the first admittance 503 produced by the uncurved field lines predominates compared with the second capacitance 504 and the second admittance 505, which are produced by the curved field lines 110.

This significantly greater component of the first capacitance 502 and of the first admittance 503 in relation to the total admittance, which is obtained from the sum of the first capacitance 502 and the second capacitance 504 as well as the first admittance 503 and the second admittance 505, has the effect of significantly increasing the sensitivity of the biosensor 500 when the state of the biosensor 500 changes, i.e. when DNA strands in the solution 114 to be analyzed hybridize with DNA probe molecules 501 immobilized on the holding regions on the electrode faces 106, 107.

Clearly, with the same lateral dimensions of the electrodes 101, 102 and the same dimensions of the previously introduced active region, i.e. with the same area of the holding regions on the electrode faces, a substantially greater component of field lines of an applied electric field between the electrodes 101, 102 is therefore contained in the volume in which the hybridization takes place when DNA strands to be recorded are contained in the solution 114 to be analyzed, than in the case of the planar electrode arrangement in accordance with the prior art.

In other words, this means that the capacitance of the arrangement according to the invention per unit chip area is significantly greater than the capacitance per unit chip area in the case of the planar electrode arrangement of the biosensor 200 in accordance with the prior art.

A few alternative possibilities for producing a cuboid sensor electrode with essentially vertical side walls will be explained below.

First Method for Producing Metal Electrodes with Essentially Vertical Side Walls, Which can Immobilize Probe Molecules

FIG. 6a shows a silicon substrate 600, as is produced for known CMOS processes. On the silicon substrate 600, which already contains integrated circuits and/or electrical terminals for the electrodes to be formed, an insulator layer 601 which is also used as a passivation layer is applied with a sufficient thickness, with a thickness of 500 nm according to the exemplary embodiment, by means of a CVD method.

The insulator layer 601 may be made of silicon oxide SiO₂ or silicon nitride Si₃N₄.

The interdigitated arrangement of the biosensor 500 according to the second exemplary embodiment is defined by means of photolithography on the insulator layer 601.

By means of a dry etching method, e.g. reactive ion etching (RIE), steps 602 are subsequently produced, i.e. etched, in the insulator layer 601 with a minimum height 603 of approximately 100 nm according to the exemplary embodiment.

The height 603 of the steps 602 must be large enough for a subsequent self-aligning process to form the metal electrode.

It should be pointed out that an evaporation coating method or a sputtering method may alternatively also be used for applying the insulator layer 601.

During the structuring of the steps 602, care should be taken that the flanks of the steps 602 are steep enough so that they form sufficiently sharp edges 605. An angle 606 of the step flanks, measured with respect to the surface of the insulator layer 601, should be at least 50 degrees according to the exemplary embodiment.

In a further step, an auxiliary layer 604 (cf. FIG. 6b) made of titanium with a thickness of approximately 10 nm is applied to the stepped insulator layer 601 by means of evaporation.

The auxiliary layer 604 may comprise tungsten and/or nickel-chromium and/or molybdenum.

It is necessary to guarantee that the metal layer applied in a further step, according to the exemplary embodiment a metal layer 607 made of gold, grows porously at the edges 605 of the steps 602 so that, in a further method step, it is possible to respectively etch a gap 608 at the step junctions, into the gold layer 607 which is applied surface-wide.

The gold layer 607 for the biosensor 500 is applied in a further method step.

According to the exemplary embodiment, the gold layer has a thickness of from approximately 500 nm to approximately 2000 nm.

In terms of the thickness of the gold layer 607, it is merely necessary to guarantee that the thickness of the gold layer 607 is sufficient for the gold layer 607 to grow porously in columns.

In a further step, openings 608 are etched into the gold layer 607 so that gaps are formed.

For wet etching of the openings, an etchant solution made up of 7.5 g Super Strip 100™ (trademark of Lea Ronal GmbH, Germany) and 20 g KCN in 1000 ml water H₂O is used.

Owing to the columnar growth of the gold, in general of the metal, during the evaporation coating onto the adhesion layer 604, anisotropic etching attack is achieved so that the surface erosion of the gold takes place approximately in the ratio 1:3.

The gaps 608 are formed as a function of the duration of the etching process by the etching of the gold layer 607.

This means that the duration of the etching process dictates the basic width, i.e. the distance 609 between the gold electrodes 610, 611 which are being formed. After the metal electrodes have a sufficient width and the distance 609 between the gold electrodes 610, 611 which are being formed is achieved, the wet etching is ended.

It should be noted that, because of the porous evaporation coating, etching in a direction parallel to the surface of the insulator layer 601 takes place substantially faster than in a direction perpendicular to the surface of the insulator layer 601.

It should be pointed out that alternatively to a gold layer, it is possible to use another noble metal, for example platinum, titanium or silver, since these materials can likewise have holding regions or can be coated with a suitable material for holding immobilized DNA probe molecules, or in general for holding probe molecules, and they exhibit columnar growth during evaporation coating.

For the case in which the adhesion layer 604 needs to be removed in the opened gaps 612 between the metal electrodes 610, 611, this is likewise carried out in a self-aligning fashion by using the gold electrodes 610, 611 as an etching mask.

Compared with the known interdigitated electrodes, the structure according to this exemplary embodiment has the advantage, in particular, that owing to the self-aligning opening of the gold layer 607 over the edges 605, the distance between the electrodes 610, 611 is not tied to a minimum resolution of the production process, i.e. the distance 609 between the electrodes 610, 611 can be kept very narrow.

According to this method, the biosensor 500 according to the second exemplary embodiment with the corresponding metal electrodes is therefore obtained.

Second Method for Producing Metal Electrodes with Essentially Vertical Side Walls, Which can Immobilize Probe Molecules

The production method represented in FIG. 7a to FIG. 7c starts with a substrate 701, for example a silicon substrate wafer (cf. FIG. 7a), on which metallization 702 is already provided as an electrical terminal, an etch stop layer 703 of silicon nitride Si₃N₄ already having been applied on the substrate 701.

A metal layer 704, according to the exemplary embodiment a gold layer 704, is applied on the substrate by means of an evaporation coating method.

Alternatively, a sputtering method or a CVD method may also be used to apply the gold layer 704 to the etch stop layer 703.

In general, the metal layer 704 comprises the metal on which the electrode to be formed is intended to be formed.

An electrically insulating auxiliary layer 705 of silicon oxide SiO₂ is applied on the gold layer 704 by means of a CVD method (alternatively by means of an evaporation coating method or a sputtering method).

By using photolithographic technology, a resist structure, for example a cuboid structure, is formed from a resist layer 706, which resist structure corresponds to the shape of the electrode to be formed.

If a biosensor array, described below, with a plurality of electrodes is to be produced, a resist structure whose shape corresponds to the electrodes to be formed, which form the biosensor array, is produced by means of photolithography.

Put another way, this means that the lateral dimensions of the resist structure which is formed correspond to the dimensions of the sensor electrode to be produced.

After application of the resist layer 706 and the corresponding illumination, which defines the corresponding resist structures, the resist structure is removed in the “undeveloped”, i.e. unilluminated regions, for example by means of ashing or wet chemically.

The auxiliary layer 705 is also removed by means of a wet etching method or a dry etching method in the regions not protected by the photoresist layer 706.

In a further step, after removal of the resist layer 706, a further metal layer 707 is applied conformally as an electrode layer over the remaining auxiliary layer 705, in such a way that the side faces 708, 709 of the residual auxiliary layer 705 are covered with the electrode material, according to the exemplary embodiment with gold (cf. FIG. 7b).

The application may be carried out by means of a CVD method or a sputtering method or by using an ion metal plasma method.

In a last step (cf. FIG. 7c), spacer etching is carried out, during which the desired structure of the electrode 710 is formed by deliberate over-etching of the metal layers 704, 707.

The electrode 710 therefore has the spacers 711, 712, which have not been etched away in the etching step of etching the metal layers 704, 707, as well as the part of the first metal layer 704, arranged immediately below the residual auxiliary layer 705, which has not been etched away by means of the etching method.

The electrode 710 is electrically coupled to the electrical terminal, i.e. the metallization 702.

The auxiliary layer 705 of silicon oxide may if necessary be removed by further etching, for example in a plasma or wet chemically, by means of a method in which selectivity with respect to the etch stop layer 703 is provided.

This is guaranteed, for example, if the auxiliary layer 705 consists of silicon oxide and the etch stop layer 703 comprises silicon nitride.

The steepness of the walls of the electrode in the biosensor 100, 500, represented by the angle 713 between the spacers 711, 712 and the surface 714 of the etch stop layer 703, is therefore determined by the steepness of the flanks of the residual auxiliary layer 705, i.e. in particular the steepness of the resist flanks 715, 716 of the structured resist layer 706.

Third Method for Producing Metal Electrodes with Essentially Vertical Side Walls, Which can Immobilize Probe Molecules

FIG. 8a to FIG. 8c represent a further possibility for producing an electrode with essentially vertical walls.

This also, as represented in the second example of producing an electrode, starts with a substrate 801 on which a metallization 802 is already provided for the electrical terminal of the biosensor electrode to be formed.

A metal layer 803 is evaporation coated as an electrode layer on the silicon substrate 801, the metal layer 803 comprising the material to be used for the electrode, according to this exemplary embodiment gold.

Alternatively to evaporation coating of the metal layer 803, the metal layer 803 may also be applied on the substrate 801 by means of a sputtering method or by means of a CVD method.

A photoresist layer 804 is applied on the metal layer 803 and is structured by means of photolithographic technology so as to produce a resist structure which, after development and removal of the developed regions, corresponds to the lateral dimensions of the electrode to be formed, or in general of the biosensor array to be formed.

The thickness of the photoresist layer 804 corresponds essentially to the height of the electrodes to be produced.

During structuring in a plasma with process gases which cannot lead to any reaction of the electrode material, in particular in an inert gas plasma, for example with argon as the process gas, the erosion of the material according to this exemplary embodiment is carried out by means of physical sputter erosion.

In this case, the electrode material is sputtered from the metal layer 803 in a redeposition process onto the essentially vertical side walls 805, 806 of the structured resist elements that are not removed after ashing the developed resist structure, where it is no longer exposed to any sputter attack.

Redeposition of electrode material onto the resist structure protects the resist structure from further erosion.

Because of the sputtering, side layers 807, 808 of the electrode material, according to the exemplary embodiment of gold, are formed at the side walls 805, 806 of the resist structure.

The side layers 807, 808 are electrically coupled to an unremoved part 809 of the metal layer 803, which lies immediately below the residual resist structure 806, and furthermore to the metallization 803 (cf. FIG. 8b).

In a last step (cf. FIG. 8c), the resist structure 806, i.e. the photoresist which is found in the volume formed by the side layers 807, 808 as well as the remaining metal layer 809, is removed by means of ashing or wet chemically.

The result is the electrode structure 810 represented in FIG. 8c, which is formed with the side walls 807, 808 as well as the unremoved part 809, which forms the bottom of the electrode structure and is electrically coupled to the metallization 803.

As in the production method presented above, the steepness of the side walls 807, 808 of the electrode that is formed in this method is determined by the steepness of the resist flanks 805, 806.

Third Exemplary Embodiment

FIG. 9a to FIG. 9c represent a further exemplary embodiment of the invention with cylindrical electrodes protruding vertically from the substrate.

In order to produce the biosensor 900 with cylindrical electrodes, which are arranged essentially vertically on a substrate 901 of silicon oxide, a metal layer 902 is applied by means of an evaporation coating method as an electrode layer of the desired electrode material, according to the exemplary embodiment of gold.

A photoresist layer is applied on the metal layer 902, and the photoresist layer is illuminated by means of a mask so that the cylindrical structure 903 represented in FIG. 9a is obtained on the metal layer 902 after the unilluminated regions have been removed.

The cylindrical structure 903 has a photoresist torus 904 as well as a cylindrical photoresist ring 905, which is arranged concentrically around the photoresist torus 904.

The photoresist is removed between the photoresist torus 904 and the photoresist ring 905, for example by means of ashing or wet chemically.

Through the use of a sputtering method, as in conjunction with the method described above for producing an electrode, a metal layer 906 is applied around the photoresist torus 904 by means of a redeposition process.

In a similar way, an inner metal layer 907 is formed around the photoresist ring 905 (cf. FIG. 9b).

In a further step, the structured photoresist material is removed by means of ashing or wet chemically, so that two cylindrical electrodes 908, 909 are formed.

The substrate 901 is removed in a last step, for example by means of a plasma etching process that is selective with respect to the electrode material, to the extent that the metallizations in the substrate are exposed and electrically couple to the cylindrical electrodes.

The inner cylindrical electrode 908 is therefore electrically coupled to a first electrical terminal 910, and the outer cylindrical electrode 909 is electrically coupled to a second electrical terminal 911.

The residual metal layer 902, which has not yet been removed by the sputtering between the cylindrical electrodes 908, 909, is removed in a last step by means of a sputter-etching process. The metal layer 902 is likewise removed in this way.

It should be mentioned in this context that, according to this exemplary embodiment as well, the metallizations for the electrical terminals 910, 911 are already provided in the substrate 901 at the start of the method.

FIG. 10 shows a plan view of a biosensor array 1000, in which cylindrical electrodes 1001, 1002 are contained.

Each first electrode 1001 has a positive electrical potential.

Each second electrode 1002 of the biosensor array 1000 has an electrical potential that is negative in relation to the respectively neighboring first electrode 1001.

The electrodes 1001, 1002 are arranged in rows 1003 and columns 1004.

The first electrodes 1001 and the second electrodes 1002 are respectively arranged alternately in each row 1003 and each column 1004, i.e. a second electrode 1002 is respectively arranged in a row 1003 or a column 1004 immediately next to a first electrode 1001, and a first electrode 1001 is respectively arranged in a row 1003 or a column 1004 next to a second electrode 1002.

This ensures that an electric field with essentially uncurved field lines in the height direction of the cylinder electrodes 1001, 1002 can be produced between the individual electrodes.

As described above, a large number of DNA probe molecules are respectively immobilized on the electrodes.

If a solution to be studied (not shown) is then applied to the biosensor array 1000, then the DNA strands hybridize with DNA probe molecules complementary thereto which are immobilized on the electrodes.

In this way, by means of the known impedance method, the existence or non-existence of DNA strands of a predetermined sequence in a solution to be studied can in turn be detected by means of the biosensor array 1000.

FIG. 11 shows a further exemplary embodiment of a biosensor array 1100 with a plurality of cuboid electrodes 1101, 1102.

The arrangement of the cuboid electrodes 1101, 1102 is in accordance with the arrangement of the cylindrical electrodes 1101, 1102 as presented in FIG. 11 and explained above.

Fourth Exemplary Embodiment

FIG. 12 shows an electrode arrangement of a biosensor 1200 according to a further exemplary embodiment of the invention.

The first electrode 101 is applied on the insulator layer 103 and is electrically coupled to the first electrical terminal 104.

The second electrode 102 is likewise applied on the insulator layer 103 and is electrically coupled to the second electrical terminal 105.

As shown in FIG. 12, the second electrode according to this exemplary embodiment has a different shape compared with the second electrode described previously.

The first electrode, as can be seen from FIG. 12, is a planar electrode and the second electrode is configured with a T-shape.

Each T-shaped second electrode has a first branch 1201, which is arranged essentially perpendicular to the surface 1207 of the insulator layer 603.

Furthermore, the second electrode 102 has second branches 1202 which are arranged perpendicular to the first branch 1201 and are arranged at least partially over the surface 1203 of the respective first electrode 101.

As can be seen in FIG. 12, several first electrodes 101 and several second electrodes 102 are connected in parallel, so that because of the T-shaped structure of the second electrode 102, a cavity 1204 is created which is formed by two second electrodes 102 arranged next to one another, one first electrode 101 and the insulator layer 103.

The individual first and second electrodes 101 and 102 are electrically insulated from one another by means of the insulator layer 103.

An opening 1205 is provided between the individual second branches 1202 of the second electrode 102 for each cavity 1204, which opening 1205 is large enough so that when an electrolyte 1206 is being applied to the biosensor 1200, the electrolyte and DNA strands possibly contained in the solution 1206 to be studied, for example an electrolyte, can pass through the opening 1205 into the cavity 1204.

DNA probe molecules 1209, which can hybridize with the corresponding DNA strands of a predetermined sequence that are to be detected, are immobilized on holding regions on the first and second electrodes.

As can be seen in FIG. 12, because of the mutually facing surfaces, aligned essentially parallel with one another, of the second electrode 1208 and of the first electrode 1203, on which the holding regions for holding the DNA probe molecules 1209 are provided, essentially uncurved field lines are formed when an electric field is applied between the first electrode 101 and the second electrode 102.

Fifth Exemplary Embodiment

FIG. 13 shows a biosensor 1300 according to a fifth exemplary embodiment of the invention.

The biosensor 1300 according to the fifth exemplary embodiment corresponds essentially to the biosensor 1200, explained above and shown in FIG. 12, in accordance with the fourth exemplary embodiment of the invention, with the difference that no holding regions with immobilized DNA probe molecules 1209 are provided on side walls of the first branch 1201 of the second electrode 102, but rather the surface 1301 of the first branch 1201 of the second electrode 102 is covered with insulator material of the insulator layer 103 or a further insulating layer.

According to the exemplary embodiment shown in FIG. 13, holding regions on the first electrode and on the second electrode 101, 102 are consequently only on directly facing surfaces of the electrodes, i.e. on the surface 1302 of the second branch of the second electrode 102 and on the surface 1303 of the first electrode 101.

FIG. 14a to FIG. 14g represent individual method steps for producing the first electrode 101 and the second electrode 102 in the biosensors 1200, 1300 in accordance with the fourth and fifth exemplary embodiments, respectively.

In the insulator layer 103 as a substrate, according to the exemplary embodiment made of silicon oxide, a structure whose shape corresponds to the first electrode 101 to be formed is etched into the insulator layer 103 by using a mask layer, for example made of photoresist.

After removal of the mask layer by ashing or by a wet chemical method, a layer of the desired electrode material is applied surface-wide on the insulator layer 103, in such a way that the previously etched structure 1401 (cf. FIG. 14a) is at least completely filled; the structure 1401 may even be overfilled (cf. FIG. 14b).

In a further step, the electrode material 1402, preferably gold, located outside the prefabricated structure 1401 is removed by means of a chemical mechanical polishing method (cf. FIG. 14c).

After the completion of the chemical mechanical polishing method, the first electrode 101 is therefore embedded flush in the insulator layer 103.

Electrode material 1402 outside, i.e. between the further second electrodes 102 or between the first electrodes 101, is removed without leaving any residue.

A cover layer 1403, for example made of silicon nitride, may furthermore be applied to the first electrode 101 by means of a suitable coating method, for example a CVD method, a sputtering method or an evaporation coating method (cf. FIG. 14d).

FIG. 14e shows several first electrodes 1401 made of gold, which are embedded next to one another in the insulator layer 103, and the cover layer 1403 located on top.

In a further step (cf. FIG. 14f), a second electrode layer 1404 is applied on the cover layer 1403.

After completed structuring of a mask layer 1406 of, for example, silicon oxide, silicon nitride or photoresist, in which the desired openings 1405 between the second electrodes are taken into account, and which is intended to be formed from the second electrode layer 1404, the desired cavities 1204 are formed according to the biosensors 1200, 1300 represented in FIG. 12 or FIG. 13 in the second electrode layer 1404 over the first electrode layer 1402, by using an isotropic etching method (dry etching method, e.g. in a downstream plasma or wet etching method) (cf. FIG. 14g).

It should be noted in this context that the cover layer 1403 is not absolutely indispensable, but it is advantageous in order to protect the first electrodes 101 from superficial etching during the formation of the cavity 1204.

In an alternative embodiment, the T-shaped structure of the second electrode 102 may be formed as follows: after forming the first electrode 101 according to the method described above, a further insulator layer is formed by means of a CVD method or another suitable coating method on the first insulator layer or, if the cover layer 1403 exists, on the cover layer 1403. Subsequently, corresponding trenches are formed in the cover layer 1403, which are used to accommodate the first branch 1201 of the T-shaped structure of the second electrode 102. These trenches are filled with the electrode material gold and, according to the Damascene method, the electrode material is removed which has been formed in the trench and above the second insulator layer by means of chemical mechanical polishing, until a predetermined height which corresponds to the height of the second branch 1202 of the T-shaped second electrode 102.

The opening 1205 between the second electrodes 102 is formed by means of photolithography, and the insulator material is subsequently removed, at least partially, by means of a dry etching method in a downstream plasma from the volume which is intended to be formed as the cavity 1204.

It should furthermore be pointed out that the embodiments described above are not restricted to an electrode whose holding region is produced by means of gold. Alternatively, electrodes may be coated in the holding regions with materials, for example with silicon monoxide or silicon dioxide, which can form a covalent bond with the aforementioned amine, acetoxy, isocyanate, alkysilane residues in order to immobilize probe molecules, in this variant in particular in order to immobilize ligands.

The Following Publications are Cited in this Document:

[1] R. Hintsche et al., Microbiosensors Using Electrodes Made in Si-Technology, Frontiers in Biosensorics, Fundamental Aspects, edited by F. W. Scheller et al., Dirk Hauser Verlag, Basle, pp. 267-283, 1997

[2] N. L. Thompson, B. C. Lagerholm, Total Internal Reflection Fluoresence: Applications in Cellular Biophysics, Current Opinion in Biotechnology, Vol. 8, pp. 58-64, 1997

[3] P. Cuatrecasas, Affinity Chromatography, Annual Revision Biochem, Vol. 40, pp. 259-278, 1971

[4] M. Engelhardt et al., Challenges in Plasma Etching and Patterning for Fabrication of New Systems and Devices, Journal of Vacuum Science & Technology A, JVST A, Second Series, Vol. 17, No. 4, Part I, pp. 1536-1538, July/August 1999

[5] D. Widmann et al., Technologie hochintegrierten Schaltungen [Large-scale integrated circuit technology], Springer Verlag, 2nd Edition, ISBN 3-540-59357-8, pp. 297-303, 1996

[6] DE 38 40 226 A1

[7] P. van Gerwen, Nanoscaled Interdigitated Electrode Arrays for Biochemical Sensors, IEEE, International Conference on Solid-State Sensors and Actuators, Chicago, pp. 907-910, Jun. 16-19, 1997

1. A biosensor, having
a first electrode with a first holding region for holding molecules which can bind macromolecular biopolymers which are to be recorded,
a second electrode having a second holding region for holding molecules which can bind the macromolecular biopolymers which are to be recorded,
the first electrode and the second electrode being arranged in such a manner relative to one another that substantially uncurved field lines of an electric field produced between the first electrode and the second electrode can form between the first holding region and the second holding region.

2. The biosensor as claimed in claim 1,
in which the first holding region is provided with a first immobilization layer, and/or
in which the second holding region is provided with a second immobilization layer.

3. The biosensor as claimed in claim 1 or 2, in which the first holding region and the second holding region are designed to hold molecules to which peptides or proteins can be bound.

4. The biosensor as claimed in claim 1 or 2, in which the first holding region and the second holding region are designed to hold molecules to which DNA molecules can be bound.

5. The biosensor as claimed in one of claims 1 to 4, in which the first holding region and the second holding region include at least one of the following materials:
hydroxyl radicals,
epoxy radicals,
amine radicals,
acetoxy radicals,
gold,
silver,
platinum,
titanium.

6. The biosensor as claimed in one of claims 1 to 5, in which the first holding region and the second holding region are formed substantially parallel to one another or concentrically.

7. The biosensor as claimed in one of claims 1 to 6, in which the first electrode and the second electrode form two walls which are arranged on a substrate, are positioned opposite one another and are substantially perpendicular to the substrate.

8. The biosensor as claimed in claim 7, in which the first electrode and the second electrode are of cuboidal design.

9. The biosensor as claimed in claim 7, in which the first electrode and the second electrode are of cylindrical form and are arranged concentrically.

10. The biosensor as claimed in claim 7, in which the first electrode and the second electrode are of polygonal form, in such a manner that respective polygon surfaces of the first electrode and of the second electrode are positioned opposite one another.

11. The biosensor as claimed in one of claims 1 to 5,
in which the first electrode is applied to an electrically insulating substrate,
in which the second electrode is applied to the electrically insulating substrate, in such a manner
a) that the second electrode, together with the substrate and the first electrode, forms a cavity, and
b) the second electrode is arranged partially above the first electrode,
c) that the surfaces of the second electrode in the cavity which are arranged above the first electrode are substantially parallel to the surface of the first electrode in the cavity,
d) the second electrode forming an opening in the cavity which is sufficiently large to allow the macromolecular biopolymers which are to be recorded to pass into the cavity.

12. The biosensor as claimed in one of claims 1 to 10,
in which a plurality of first electrodes and a plurality of second electrodes are provided,
in which the first electrodes and the second electrodes are connected in parallel, so that they form an interdigitated arrangement.

13. The biosensor as claimed in one of claims 1 to 12, in which the electrodes include at least one of the following metals:
gold,
silver,
platinum,
titanium.

14. A biosensor array having a multiplicity of biosensors as claimed in one of claims 1 to 13.

15. The biosensor array as claimed in claim 14, in which electrodes of opposite electrical polarity are in each case arranged immediately adjacent to the electrodes of the same electrical polarity, so that an electric field can form between the electrodes.

16. A method for producing a biosensor,
in which a structure, the shape of which corresponds to a first electrode which is to be formed, is formed in a substrate comprising electrically insulating material,
in which the structure is at least completely filled with electrode material,
in which the electrode material which is situated above and outside the structure is removed, so that the first electrode is formed,
in which substantially vertical walls, comprising electrode material, of a second electrode which is to be formed are formed, the substantially vertical walls being electrically insulated from the first electrode,
in which an auxiliary layer is applied to the substrate to a maximum height of the substantially vertical walls,
in which an electrode layer is applied to the auxiliary layer, in such a manner that the electrode layer is coupled in an electrically conductive manner to the substantially vertical walls,
in which an opening is formed in the electrode layer,
in which the auxiliary layer is at least partially removed, through the opening, in the space formed by the electrode layer, the substrate, the first electrode, the substantially vertical walls and the electrode layer.

17. A method for producing an electrode of a biosensor,
in which a structure, the shape of which corresponds to an electrode which is to be formed, is formed in a substrate comprising electrically insulating material,
in which the structure is at least completely filled with electrode material,
in which the electrode material which is situated above and outside the structure is removed, so that the electrode is formed in the substrate.

18. The method as claimed in claim 16 or 17, in which the auxiliary layer is completely removed.

19. The method as claimed in one of claims 16 to 18, in which the auxiliary layer is removed by means of dry etching.

20. The method as claimed in claim 19, in which the dry etching takes place in a downstream plasma.

21. A method for producing an electrode of a biosensor,
in which a first electrode layer comprising electrode material is applied to a substrate having a metallization for an electrical connection of the biosensor which is to be formed,
in which an auxiliary layer comprising electrically insulating material is applied to the first electrode layer,
in which the auxiliary layer is structured in such a manner that a structure which is in the form of at least one electrode which is to be formed, with substantially vertical walls, results,
in which a second electrode layer comprising electrode material is applied to the first electrode layer and the remaining auxiliary layer, in such a manner that the vertical walls of the structure are covered with electrode material,
in which the electrode material is removed apart from the electrode material at the vertical side walls and immediately below the structure.

22. The method as claimed in claim 21, in which as part of the structuring, resist structures whose lateral dimensions correspond to the electrode which is to be produced are produced by means of photolithography.

23. The method as claimed in claim 21 or 22, in which silicon oxide is used for the auxiliary layer.

24. The method as claimed in one of claims 21 to 23, in which an etching stop layer is formed on the substrate.

25. The method as claimed in claim 24, in which silicon nitride is used for the etching stop layer.

26. The method as claimed in one of claims 21 to 25, in which the electrode material is removed by means of a polishing process.

27. The method as claimed in claim 26, in which the electrode material is removed by means of a chemical mechanical polishing process.

28. A method for producing an electrode of a biosensor,
in which an electrode layer comprising electrode material is applied to a substrate having a metallization for an electrical connection of the biosensor which is to be formed,
in which a resist layer comprising photoresist is applied to the electrode layer, the thickness of the resist layer substantially corresponding to the height of the electrode of the biosensor which is to be formed,
in which the resist layer is structured in such a manner that the lateral dimensions of the structure produced correspond to the electrode which is to be produced,
in which the regions of the electrode layer which have been uncovered by the structuring are removed in such a manner that, during the removal, in a redeposition process electrode material accumulates at the substantially vertical walls of the structured resist layer.

29. The method as claimed in claim 28, in which the electrode material of the uncovered regions of the electrode layer is removed by sputtering.

30. A method for producing an electrode of a biosensor,
in which a stepped structure with side walls of a predetermined steepness is formed in a substrate,
in which a metal adhesion layer is applied to the substrate,
in which a metal layer is vapor-deposited on the metal adhesion layer,
in which the metal layer is opened up in a self-aligning manner at each edge of the stepped structure, so that a gap is formed in the metal layer in such a manner that the metal electrodes are electrically insulated from the metal electrodes which in each case directly adjoin them.

31. The method as claimed in claim 30, in which one of the following materials is used for the metal adhesion layer:
titanium,
tungsten,
nickel-chromium, or
molybdenum.

32. The method as claimed in claim 30 or 31, in which one of the following materials is used for the metal layer:
gold,
silver,
platinum,
titanium.

33. The method as claimed in one of claims 30 to 32, in which each step of the stepped structure is formed with a height of at least 100 nm.

34. The method as claimed in one of claims 30 to 33, in which the metal layer is formed with a thickness which is sufficient for the metal layer to grow together in porous form.

35. The method as claimed in claim 34, in which the metal layer is formed with a thickness of approximately 500 nm to 2000 nm.

36. The method as claimed in one of claims 30 to 35, in which the metal layer is opened up in a self-aligning manner as a result of the metal layer being etched.

37. The method as claimed in claim 36, in which the metal layer is opened up in a self-aligning manner as a result of the metal layer being wet-etched.
